(19) United States
(12) Patent Application Publication
(10) Pub. No.: US 2009/0098513 A1
(43) Pub. Date: Apr. 16, 2009

(54) Coping material for prosthetic tooth crown with bio gold strip mechanically bonded at the lower brim thereof

(76) Inventor: Sang Ki Kim, Anaheim, CA (US)

Correspondence Address: Eugene Oak, 610 S. Van Ness Ave., Los Angeles, CA, 90005, US

(21) Appl. No.: 11/974,482

(22) Filed: Oct. 15, 2007

(51) Int. Cl. A61C 5/09; A61C 5/10

(52) U.S. Cl. 433/222.1; 433/223

(57) ABSTRACT

A coping material for a prosthetic crown is provided. The coping material according to current application is comprised of two portions which are mechanically bonded each other. The first portion is the main coping portion that is located beneath of the enamel layer of a crown. The first portion is made from, including but not limited to, common metal and/or portion fused gold (PFG). The second is the portion which makes contact with gum tissue. That portion surrounds the brim of the bottom of the coping for 360 degrees. The gum contacting portion is comprised of bio-gold that is mechanically bonded to the main coping portion. Centrifuging of molten bio-gold technology is applied for mechanical bonding of the two portions. Electronic forming technology is also applied for mechanical bonding.

### FIELD OF INVENTION

The current application relates to a coping material for a prosthetic dental crown, especially to a coping material that has a mechanically bonded bio gold portion surrounding brim of the bottom thereof.

### BACKGROUND OF THE INVENTION

The three kind of material currently used as coping elements for prosthetic crowns are 1) common metals, 2) noble metals such as gold, silver, tantalum, platinum, palladium, etc., and 3) inorganic material such as alumina or zirconia. Common metals were most popular and were used in about 70% of the market share for the cost; however, due to their non-compatibility with gum tissue, the market share decreased. Among the noble metals, gold is more compatible with gum tissue: But, gold fittings are too soft to stand the strong biting force of teeth if the purity of gold is over 60%. Therefore, application of gold is limited to single crown. Among other noble metals, palladium and silver changes its color after some period where the metal directly contacts with gum tissue of a wearer. Platinum is cost inefficient. Inorganic materials, such as alumina and zirconia, are compatible with gum tissue. But, they are cost prohibitive due to the increased cost of manufacture. The purpose of the current application is to provide an economic and compatible coping material for a dental crown that is a non irritant to the gum tissue such as gold and at the same time has mechanical strength hard enough to resist prolonged exposure to the biting force of teeth by utilizing mechanical bonding technology.

### DESCRIPTION OF THE PRIOR ART

U.S. Pat. No. 5,853,661 to Fischer illustrates a gold content bio—compatible dental alloy. A high gold content dental alloy comprises, on a weight basis, 91 to 99.4% of gold, 0.5 to 3% of at least one metal selected from titanium and tantalum, up to 5% of silver, 0.05 to 1% of iridium and/or tungsten, and up to 1% at least one element selected from the group comprising rhodium, ruthenium, platinum, osmium, iron, molybdenum, niobium and rhenium. U.S. Pat. No. 5,131,847, to Ijuin, discloses a method of making a prosthetic dental crown using metallic foils with noble metals mostly based from combination of either Au, or Pt, and alloys. The foil is coated over the denture and molded to the shape of the denture to create the enamel. However, this method requires the use of high temperature to fuse the metals and can only be used in prosthetic teeth before they are cooled and implanted to the patient.

U.S. Pat. No. 4,492,579, to Shoher, discloses a metallic dental jacket crown and coated with a noble metal. The application also discloses a relatively low fusing temperature to make such jacket. The jacket is of 2 thin foil layers, one from a metallic alloy ranging from 15 microns to 50 microns, and the other from a pure form of noble metal, preferably Au, between 15 microns to 25 microns.

The Au foil is thinner than the alloy substrate foil. A lower fusing temperature due to thinner Au layer and the fact that pure Au is an easy malleable metal. The foils can then become the jacket by pluralities of triangular folds and then is able to engulf the prosthetic crown. After that the jacket can be thermally fused to the tooth. However, since thermal fusing is required this method is only suitable for prosthetic teeth and not for real teeth.

U.S. Pat. No. 4,861,267, to Shoher, discloses a metallic dental jacket from foil very similar to U.S. Pat. No. 4,492,579. The difference being that in this application the jacket is comprised of 3 thin and slitted metallic foils with the slit made radially on the foils. The slitting allows the foils to roll into a cone shaped jacket; which can then engulf the prosthetic crown. However, just as U.S. Pat. No. 4,492,579, thermal fusion is required so this method is also not suited for real teeth.

U.S. Pat. No. 4,392,829, to Tanaka, discloses a method of making a prosthetic crown made from Au alloys that can be used to avoid any fractures that porcelain tend to have due to the crystalline structure of the porcelain. The fissure avoidance can takes place when the porcelain is directly fused with the Au alloy by baking. The metal of choice in this application is Au because porcelain can fuse with the Au layer to minimize fissures, by having the thermal coefficient expansion close to the porcelain; and the non-corrosive and non-oxidizing properties that are associated with Au so it's suitable to make contact with living gum tissue. However, this application requires that the bonding take place via baking. The high temperature makes this procedure unsuitable for real tooth due to damage to living tissue.

None of the Prior Art describes a way to implant prosthetic crown enamel on teeth without the need of thermal bonding. It is the object of the current application to correct the deficiencies of the Prior Art.

### SUMMARY OF THE INVENTION

Common metals were most popular and were used in about 70% of the market share for the cost; however, due to the non-compatibility with gum tissue discoloration of crowning, their market share decreased. Among the noble metals, gold is more compatible with gum tissue: But, gold is too soft to stand the strong biting force of teeth if the purity of gold is over 60%. Application of gold is limited to single crown. Among other noble metals, palladium and silver changes its color after some period where the metal directly contacts with gum tissue of a wearer. Platinum is cost inefficient. Inorganic materials, such as alumina and zirconia, are compatible with gum tissue. But, they are cost prohibitive. The purpose of the current application is to provide an economical and compatible coping material, comprised of common or noble metal, for a dental crown that is a non irritant to the gum tissue such as gold and at the same time has mechanical strength hard enough to resist prolonged exposure to the biting force of teeth by utilizing mechanical bonding technology. Bio gold, which has high gold content dental alloy comprises, on a weight basis, above 99% of gold, 0.5 to 1% of at least one noble metal, is mechanically bonded to a coping material that is made of common or noble metal. The bio gold is mechanically bonded to common or noble metal via centrifugal force at high temperature above melting point of the bio-gold. Another method is depositing the bio gold on common or noble metal via electronic forming technology. Bio-gold is tightly bonded to the common or noble metal and at least four holes and two grooves are developed on the brim of the bottom of the coping material to reinforce mechanical bonding of the two materials.

### BRIEF DESCRIPTION OF THE DRAWINGS

FIG. 1 is a perspective view of a main body of a coping according to the first embodiment of the current application.

FIG. 1-a is a cross-sectional side view of a prosthetic crown, wherein bio-gold is mechanically bonded to the lower brim of the main body of a coping according to the first embodiment of the current application.

FIG. 1-b is a schematic enlarged cross-sectional view of section ‘A’ in the FIG. 1 showing the detail structure of mechanically bonded bio-gold to the lower brim of the main body of a coping according to the first embodiment of the current application.

FIG. 1-c is a cross-sectional bottom view of section ‘A’ in the FIG. 1-a seen along the line “C-C′” showing the additional reinforced structure of the mechanically bonded bio-gold to the lower brim of the main body of a coping according to the first embodiment of the current application.

FIG. 2 is a perspective view of a main body of a coping according to the second embodiment of the current application.

FIG. 2-a is a cross-sectional side view of a prosthetic crown, wherein bio-gold is mechanically bonded to the lower brim of the main body of a coping according to the second embodiment of the current application.

FIG. 2-b is a schematic enlarged cross-sectional view of section ‘D’ in the FIG. 2 showing the detail structure of mechanically bonded bio-gold to the lower brim of the main body of a coping according to the first embodiment of the current application.

FIG. 2-c is a cross-sectional bottom view of section ‘B’ in the FIG. 2 seen along the line “E-E′” showing the additional reinforced structure of the mechanically bonded bio-gold to the lower brim of the main body of a coping according to the first embodiment of the current application.

FIG. 3 is a front cross-sectional view of a pontic that shows abutment of 3 unit bridge and metal coping structure thereof.

### DETAILED DESCRIPTION OF THE PREFERRED EMBODIMENTS

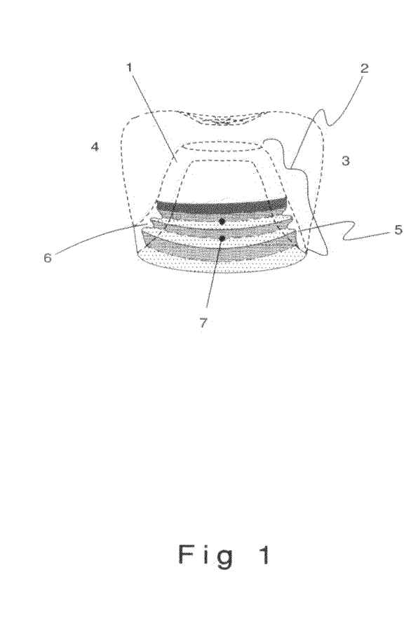

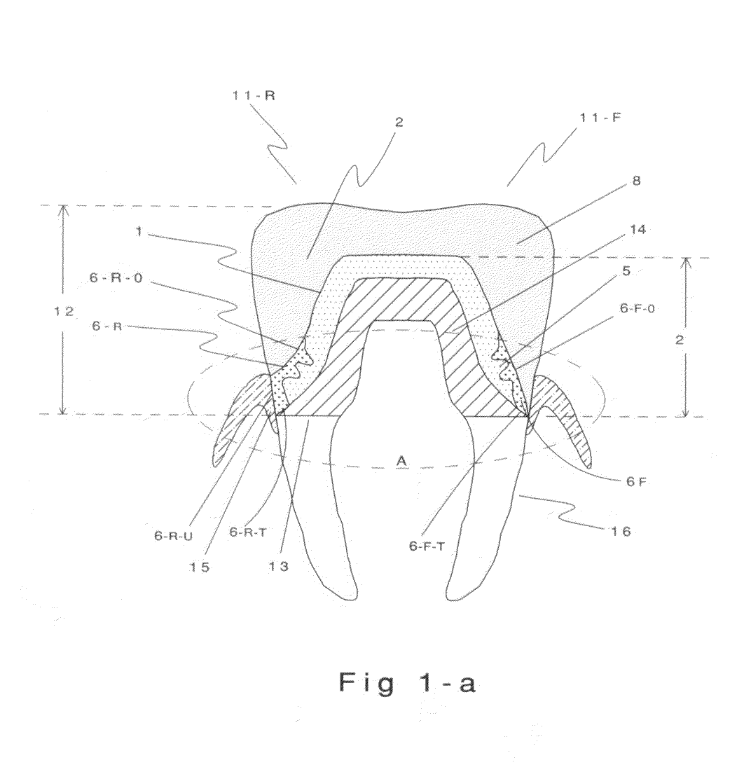

FIG. 1 is a perspective view of a main body (1) of a coping (2) according to the first embodiment of the current application. The main body (1) of the coping (2) according to current invention has un-symmetric cap-like structure. The main body (1) of the coping (2) has a front face (3) and a rear face (4). The front face (3) faces lips of a wearer and rear face (4) faces inside of mouth of the wearer. The main body (1) of the coping (2) has at least two grooves (5) that are developed at the lower brim of the main body (1) to receive bio gold (6) there on. At least four pin holes (7) are developed on the chasm of each groove (5). Part of the molten bio gold (6) smeared into the pin hole and hold the gold (6) more firmly. The main body (1) and mechanically bonded bio-gold (6) constitute the coping (2). Rear face (4) of main body (1) is shorter than the front face (3) of the main body (1) of the coping.

FIG. 1-a is an exploded cross-sectional side view of a tooth (11) with a prosthetic crown (12), wherein bio gold (6) is mechanically bonded with main body (1) of metal coping (2). The tooth (11) has a front face (11-F) and a rear face (11-R). The tooth has a coping (2), which is comprised of the main body (1) and the bio gold (6) that is mechanically bonded to the bottom of the main body (1) surrounding the brim thereof. The coping (2) is covered by a porcelain enamel layer (8).

When the crown (12) of the tooth (11) is exactly matched with a margin (13) of a preparation (14), the bio-gold casting on the rear face (4) of the coping (2), indicated as rear gold casting (6-R) contacts along with gum tissue (15) of the patient. The dentistry cementates the coping (2) and porcelain enamel layer (8) on the preparation (14) of remaining root (16) of the patient's original tooth. And then, the dentistry controls shades of the porcelain enamel layer (8) to match with the shade of the neighboring tooth of the patient. By the method describe above, a patient can have a gold margined prosthetic crown without taking out the whole tooth and without damaging any tissue. The overall shape of the prosthetic tooth (11) utilizing a coping (2) provided according to the current application is very natural as if there was no surgery.

FIG. 1-b is a schematic enlarged cross-sectional view of section ‘A’ in the FIG. 1-a showing the detail structure of mechanically bonded bio-gold (6) casted to the lower brim outer surface of the main body (1) of a coping (2) according to the first embodiment of the current application. Actually the bio-gold (6) is casted around the bottom portion of the main body (1) of the coping. However, shape of the front bio-gold casting (6-F) is designed differently from that of the rear bio-gold casting (6-R) for frontal appearance of the prosthetic tooth (11) and contact with gum tissue (15) of the patient. The front bio-gold casting (6-F) has a flat outer surfaces (6-F-O) that contact with the porcelain enamel layer (8) is at least longer than 0.3 mm. The rear bio-gold casting (6-R) is in an elbow shape. Outer surface (6-R-O) of the rear bio-gold casting (6-R) is covered with porcelain enamel layer (8). Length of the outer surfaces (6-R-O) that contact with the porcelain enamel layer (8) is at least longer than 0.3 mm. The other surface (6-R-U) of the elbow shaped rear bio-gold casting (6-R) contacts with gum tissue (15) of the patient. Height of that surface (6-R-U) is at least longer than 0.2 mm. The length of the rear prep is the same as the length of margin. Tip (6-F-T) of the front gold casting (6-F) and tip (6-R-T) of the rear gold casting (6-R) are adhered to the preparation (14). Height of the front gold casting's tip (6-F-T) is at least longer than 0.1 mm. And height of the rear gold casting's tip (6-R-T) that adheres to the preparation is at least longer than 0.1 mm. Shape and volume of inner side of the coping (4) exactly matches with the preparation (14). The grooves (5) are developed along the brim of the bottom of the main body (1) of the coping (2) to receive the Gold or bio-gold casting (6-R) and (6-F) via mechanical bonding.

FIG. 1-C is a cross-sectional bottom view of section ‘A’ in the FIG. 1-a seen along the line “B-B′” showing the additional reinforced structure of the mechanically bonded bio-gold to the lower brim of the main body (1) of a coping (2) according to the first embodiment of the current application. At least four pin holes (7) are developed on the chasm of each groove (5). The diameter and depth of the pin holes (7) are 0.1 mm and 0.2 mm respectively. Same numbers of pins (17) are developed while other portion of the bio-gold is mechanically bonded along the outer surface of the lower brim of the main body (1) of the coping (2). At the same time, tips (6-F-T) and (6-R-T) of the bio gold casting (6) are mechanically bonded to the preparation (14) at the bottom thereof.

The structure of grooves (5) combined with pin (17) and pin hole (7) reinforces the strength of mechanical bonding between the bio-gold casting (6), the main body (1) of the coping (2), and the preparation (14).

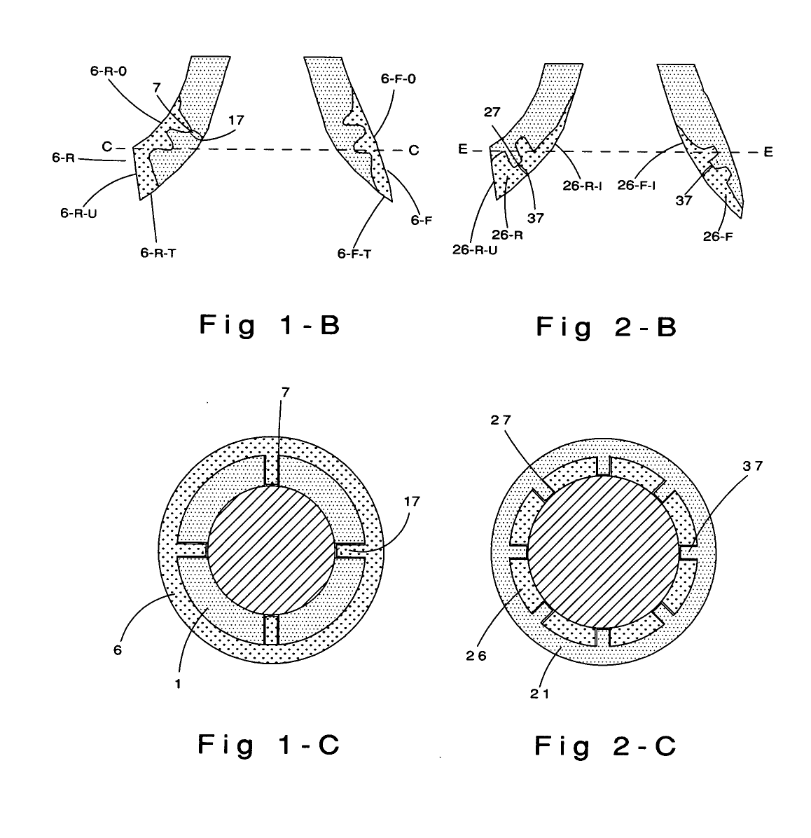

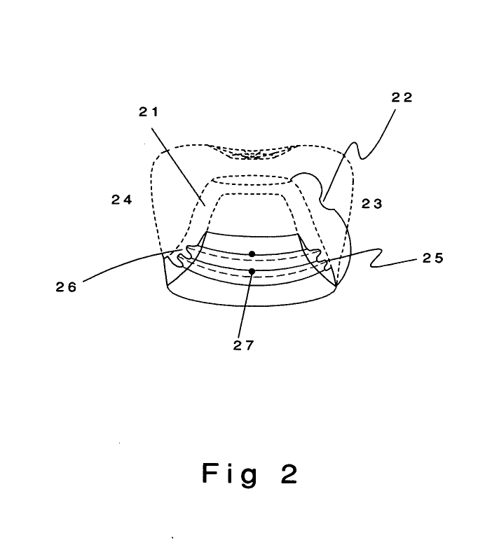

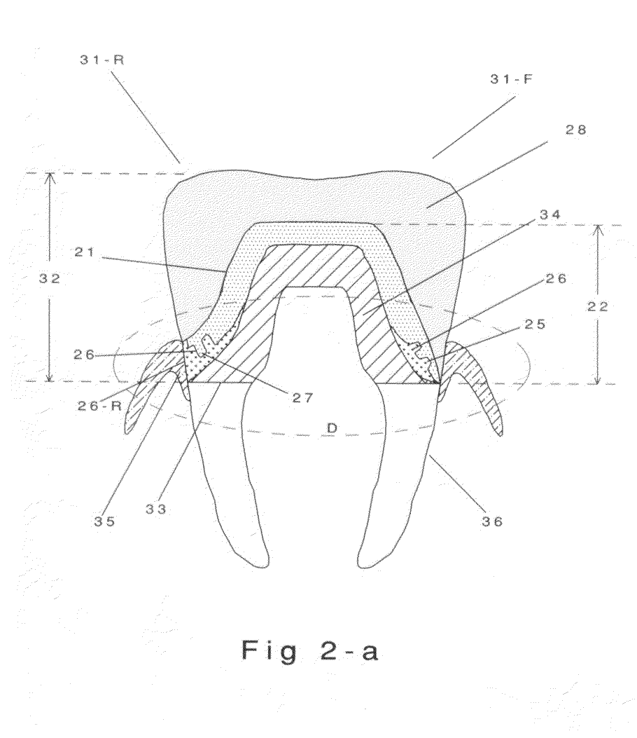

FIG. 2 is a perspective view of a main body (21) of a coping (22) according to the second embodiment of the current application. The main body (21) of the coping (22) according to the second embodiment of the current invention has un-symmetric cap-like structure. The main body (21) of the coping (22) has a front face (23) and a rear face (24). The front face (23) faces lips of a wearer and rear face (24) faces inside of mouth of the wearer. The main body (21) of the coping (22) has at least two grooves (25) that are developed inside of the main body (21) at the lower inner brim to receive bio gold (26) there on. At least eight pin holes (27) are developed on the chasm of each groove (25). Part of the molten bio gold (26) smeared into the pin hole and hold the gold (26) more firmly. The main body (21) and mechanically bonded bio-gold (26) constitute the coping (22). Rear face (24) of main body (21) is shorter than the front face (23) of the main body (21) of the coping (22).

FIG. 2-a is an exploded cross-sectional side view of a tooth (31) with a prosthetic crown (32), wherein bio gold (26) is mechanically bonded with main body (21) of non metal coping (22). The tooth (31) has a front face (31-F) and a rear face (31-R). The tooth has a coping (32), which is comprised of the main body (21) and the bio gold (26) that is mechanically bonded to the bottom of the main body (21) surrounding the brim thereof. The coping (22) is covered by a porcelain enamel layer (28).

When the crown (32) of the tooth (31) is exactly matched with a margin (33) of a preparation (34), the bio-gold casting on the rear face (24) of the coping (22), indicated as rear gold casting (26-R) contacts along with gum tissue (35) of the patient. The dentistry cementates the coping (22) and porcelain enamel layer (28) on the preparation (34) of remaining root (36) of the patient's original tooth. And then, the dentistry controls shades of the porcelain enamel layer (28) to match with the shade of the neighboring tooth of the patient. By the method describe above, a patient can have a gold margined prosthetic crown without taking out the whole tooth and without damaging any tissue. The overall shape of the prosthetic tooth (31) utilizing a coping (22) provided according to the current application is very natural as if there was no surgery.

FIG. 2-b is a schematic enlarged cross-sectional view of section ‘D’ in the FIG. 2 showing the detail structure of mechanically bonded bio-gold (26) to the lower brim of the main body (21) of a coping (22) according to second embodiment of the current application.

However, shape of the front bio-gold casting (26-F) is designed differently from that of the rear bio-gold casting (26-R) for frontal appearance of the prosthetic tooth (31) and contact with gum tissue (35) of the patient.

The front bio-gold casting (26-F) has a flat inner surfaces (26-F-I) that contacts with the preparation (34) and is at least longer than 0.3 mm. The rear bio-gold casting (26-R) is in an elbow shape. Inner surface (26-R-I) of the rear bio-gold casting (26-R) contacts with the preparation (34). Length of the inner surfaces (26-R-I) that contact with the preparation (34) is at least longer than 0.3 mm. The other surface (26-R-U′) of the elbow shaped rear bio-gold casting (26-R) contacts with gum tissue (35) of the patient. Height of that surface (26-R-U′) is at least longer than 0.2 mm. The length of the rear prep is the same as the length of margin. Shape and volume of inner side of the coping exactly matches with the preparation (34). The grooves (25) are developed along the inside brim of the bottom of the main body (21) of the coping (22) to receive the Gold or bio-gold casting (26-R) and (26-F) via mechanical bonding.

FIG. 2-C is a cross-sectional bottom view of section ‘D’ in the FIG. 2-a seen along the line “E-E′” showing the additional reinforced structure of the mechanically bonded bio-gold to the lower brim of the main body (21) of a coping (22) according to the first embodiment of the current application. At least eight pin holes (27) are developed on the chasm of each groove (25). The diameter and depth of the pin holes (27) are 0.1 mm and 0.2 mm respectively. Same numbers of pins (37) are developed while other portion of the bio-gold is mechanically bonded along the inner surface of the lower brim of the main body (21) of the coping (22). At the same time, tips of the bio gold casting (26) are mechanically bonded to the preparation (34) at the bottom thereof.

The structure of grooves (25) combined with pin (37) and pin hole (27) reinforces the strength of mechanical bonding between the bio-gold casting (26), the main body (21) of the coping (22), and the preparation (34).

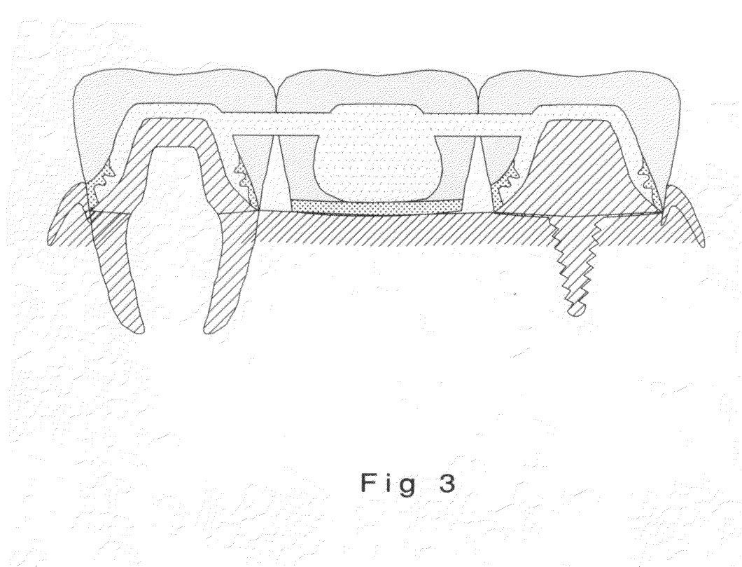

FIG. 3 is a front cross-sectional view of a pontic that shows abutment of 3 unit bridge and metal coping structure thereof.

What is claimed is:

1. A coping material for a prosthetic crown that is comprised of;
a first portion is the main coping portion that is located beneath of the enamel layer of a crown and is made from common metal,
and
a second portion is that contacts with gum tissue
and
that surrounds the brim of the bottom of the first portion for 360 degrees
and
that is comprised of bio-gold that is mechanically bonded to the main coping portion.

2. A coping material for a prosthetic crown of claim 1 wherein the first portion and the second portion is mechanically bonded by centrifuging of molten bio-gold technology.

3. A coping material for a prosthetic crown of claim 1 wherein the first portion and the second portion is mechanically bonded by electronic forming technology.
